(19) United States
(12) Patent Application Publication
(10) Pub. No.: US 2006/0188364 A1
(43) Pub. Date: Aug. 24, 2006

(54) Vertical axis wind turbine

(76) Inventor: Mike J. Fritz, Tapalpa (MX)

Correspondence Address: Mr. James Fritz, P. O. Box 427, Great Cacapon, WV, 25422, US

(21) Appl. No.: 11/357,048

(22) Filed: Feb. 21, 2006

Related U.S. Application Data
(60) Provisional application No. 60/654,894, filed on Feb. 22, 2005.

(51) Int. Cl. F03D 7/06

(52) U.S. Cl. 415/4.2

(57) ABSTRACT

The United States of America consumes nearly 20 million barrels of oil a day, 6.6 billion per year. This depleting chemical composition, in part, ends up in our air, on our trees, on our clothing, in our lungs, in our blood streams. A large portion of this oil is imported causing a dependency on foreign countries and a significant economic burden to this country. Clean, renewable, domestic energy is a necessity, not a luxury. The Z-333 Energy Management System is an answer to this challenge. There have been many Vertical Axis Wind Turbine patents issued since Mr. Elhanan L. Stoners' patent in 1891. However it appears that none has yet manifested itself into a large scale economic reality. The Z-333 Energy Management System is the latest of a series of improved Vertical Axis Wind Turbine designs which will make that reality come to pass. The Z-333 Energy Management System includes several novel changes to previously patented designs, plus incorporates totally new accessories to make man's continuing conquest of wind an actuality. These innovations include; Aerodynamic “balanced” wings. Tightly stretched fabric-only wings strengthening the overall structure, and at the same time, drastically lower the cost of construction. Flexible photovoltaic cells cover the aforementioned fabric-only-wings. A rotating tower that is flexible and safer. A unique high winds shut off switch. A multi-generator braking system maintains the shaft at a constant RPM. Generators and gears mounted to removable panels. Rubber-like covered shaft and large ring transmission. A low cost switch that controls the angle of attack of the wing with less problems and cost. A tower made of prefabricated interchangeable modules that can be used as a home, water tank, storage room, shop, and/or a shed. A base which is also a large battery and/or a control box shell. A programmable intelligent control box, which notifies the owner by cell phone, of battery fast charge/discharge, vandalism, key energy indicators, integrates a multi-circuit station timer, plus provides an electric-fence-like shock protection from animals and vandals. Low cost, multi-pancake generator that is highly efficient. A shaft centered flywheel. A shaft centered centrifugal pump. A sea base with ballast for low cost erection. A sea base with desalinization equipment built inside. A sea base with integrated hydrogen and oxygen producing equipment.

### CROSS-REFERENCE TO RELATED APPLICATION

This application claims the benefit of Provisional Patent application Ser. No. 60/654,894 filed Feb. 22, 2005.

### BACKGROUND OF THE INVENTION

Vertical Axis Wind Turbines, in which the variation of the pitch angle of the wings (blades, or airfoil) is achieved, are well known. In this regard, attention is directed to the following US patents which generally disclose Vertical Axis Wind Turbines (VAWT).

| Name | Patent Number | Issued Date |
|---|---|---|
| Stoner | 457,384 | Aug. 11, 1891 |
| Carlson | 622,115 | Mar. 28, 1899 |
| Stalker | 1,953,444 | Jul. 23, 1932 |
| Zanoski | 2,038,467 | Aug. 30, 1934 |
| Chevreau | 2,622,686 | Dec. 23, 1952 |
| Haas | 4,032,257 | Jun. 28, 1977 Key prior art |
| Thomas | 4,115,027 | Sep. 19, 1978 |
| Telford | 4,137,009 | Jan. 30, 1979 |
| Wuenscher | 4,247,251 | Jan. 27, 1981 |
| Seki | 4,247,252 | Jan. 27, 1981 |
| Zheng | 4,435,124 | Mar. 6, 1984 |
| Storm | 4,619,585 | Oct. 28, 1986 |
| Lew | 4,286,922 | Sep. 1, 1981 |
| Gutierez | 5,193,978 | Mar. 16, 1993 |
| Brown | 5,503,525 | Apr. 2, 1996 |
| Hirai | 6,379,115 | Apr. 30, 2002 |

In regards to the multi-generator system:

| | |
|---|---|
| 4,585,950 | Apr. 30, 1986 |

In regards to the semi-submergible base:

| | | |
|---|---|---|
| Porter | 3,988,592 | October 1976 |
| Wiedemann | 4,159,427 | June 1979 |
| Boswell | 4,422,825 | December 1983 |
| Schremp | 5,549,445 | August 1996 |
| Pflanz | 6,100,600 | August 2000 |
| Lagerwey | 6,294,844 | September 2001 |

In regards to the photo-voltaic cell use with wind turbines:

| | | |
|---|---|---|
| Kelly | 4,119,863 | October 1978 |

In regards to desalination system:

| | | |
|---|---|---|
| Bird | 6,083,382 | July 2000 |

There are several patents which appear similar to the Z-333 Energy Management Systems Vertical Axis Wind Turbine. U.S. Pat. No. 6,379,115B1 apparently shows an aerodynamically “balanced” wings however uses several expensive servo motors to adjust the pitch of the wings. The Z-333 Energy Management System uses a simple switch eliminating the expensive costs and problems of servo motors, maintenance, switching and thousands of feet of heavy wiring.

U.S. Pat. Nos. 5,503,525 and 4,247,251 use rudders to control their wings pitch but the wings and rudders are not aerodynamically “balanced” causing undue stress on the system thus costing more in maintenance, and using more energy positioning the wing's ‘angle of attack’.

U.S. Pat. Nos. 622,115/1,953,444/2,038,467/4,032,257/5,503,525 appear similar but are not aerodynamically “balanced”.

U.S. Pat. Nos. 4,115,027 and 4,247,252 wings appear to be “balanced” but do not pivot on the wings axis.

U.S. Pat. Nos. 4,435,124/4,619,585/5,193,978 wings do not appear to be “balanced” and do not rotate.

U.S. Pat. No. 4,286,922 wings appears to be “balanced” but is controlled from the center shaft.

The closest prior art would be that of Mr. Hendrik Antoon Loremtz de Haas, U.S. Pat. No. 4,032,257. The differences are as follows;

1) The Haas patent uses a counterweight (item # 40 FIG. 2) to physically balance the wing. The Z-333 Energy Management Systems Vertical Axis Wind Turbine uses 95% more wing. This physically balances the wing plus gives it 95% more power. For example, if the entire wing is 19 feet long, the pivot point would be located 9 feet from the wings leading edge and 10 feet from the wings trailing edge. Any counterweight, if needed, could be obtained by creating an envelope folding the leading edge of the wing, sealing it, and filling it with sand or other weight.

2) The Haas patent only captures energy from about one third of the circle. Imagine you are viewing the wings “flight” circle from the top, like a clock. Use 12:00 o'clock as the direction which the wind comes from. The “flight” path is counter clockwise. The Haas patent only captures energy from about the 11:00 o'clock position to the 7:00 o'clock position. The Z-333 Energy Management Systems Vertical Axis Wind Turbine captures energy from about the 2:00 o'clock position to the 4:00 o'clock position, or about two thirds of the “flight” circle.

3) The Haas patent has fixed “pegs” to stop the wings rotating movement. The Z-333 Energy Management Systems Vertical Axis Wind Turbine uses spring activated switche, a large spring and a brake. The spring action of the switch enables the wing to move into the correct position when the wind changes direction and it is needed for the wing to move to the other side. The other spring action of the switch enables the wing to feather and face its leading edge into the wind during high winds. This provides an additional safety mechanism. If the wing changes direction with the Haas patent one wing of the wind turbine could “lock” in a counter position causing it to “fight” the other wings. Also in case of high winds the wing of the Haas patent, could be in a position causing the entire wind turbine to be at risk of total destruction, or to be built at a prohibited high cost.

No other above mentioned patent has a fabric-only wing tightly stretched from top to bottom as an integral part of its overall structure. All other patents have wings which use spars, metal or plywood etc.

In regards to the multi-generator system, there is U.S. Pat. No. 4,585,950 for a high speed, Horizontal Axis Wind Turbine. This is used to maintain the electrical output at a certain frequency. The Z-333 Energy Management Systems Vertical Axis Wind Turbine uses the multi-generator to maintain the vertical shaft, at a semi-fixed slow RPM speed.

In regards to a semi-submergible wind turbine base there are U.S. Pat. Nos. 3,988,592/4,159,427/4,422,825/5,549,445/6,100,600/6,294,844. The Z-333 Energy Management Systems Vertical Axis Wind Turbine has ballast which enables the entire structure to be assembled on its side, then by filling the ballast, it automatically erects. Only the Z-333 Energy Management Systems Vertical Axis Wind Turbine incorporates a ballast erected wind turbine tower base for low cost on-water erection.

Only the Z-333 Energy Management Systems Vertical Axis Wind Turbine incorporates a center axis flywheel.

Only the Z-333 Energy Management Systems Vertical Axis Wind Turbine incorporates a center axis centrifugal pump.

Only the Z-333 Energy Management Systems Vertical Axis Wind Turbine incorporates a reverse osmosis, or other desalinization system into the wind turbine tower base.

In regards to the photo-voltaic cell wings, there is U.S. Pat. No. 4,119,863, which uses photo-voltaic cell panels. The Z-333 Energy Management Systems Vertical Axis Wind Turbine has thin, lightweight, and somewhat flexible photo-voltaic cells, glued to the fabric-only wings.

In regards to the Power House base there are several wind turbines which have buildings as bases. The Z-333 Energy Management Systems Vertical Axis Wind Turbine is unique in that it has a tower with prefabricated sections which may be interchange to fit the end users needs.

Only the Z-333 Energy Management Systems Vertical Axis Wind Turbine incorporates a center axis pancake generator which is made from several chemically etched circuit boards.

Only the Z-333 Energy Management Systems Vertical Axis Wind Turbine incorporates a flexible safety tower which bends in high winds instead of breaking.

Only the Z-333 Energy Management Systems Vertical Axis Wind Turbine incorporates a rubber-like covered shaft engaged with a large smooth metal ring to step up the revolutions and transmit the energy from the shaft to the generator.

Only the Z-333 Energy Management Systems Vertical Axis Wind Turbine incorporates a programmable intelligent control box, which notifies the owner by internet or cell phone, of battery fast over/discharge, vandalism, key energy indicators, and also integrates a multi-circuit timer, plus provides electric-fence type of shock to protect it from animals and vandals.

Only the Z-333 Energy Management Systems Vertical Axis Wind Turbine has a base which is a battery and/or control box.

### SUMMARY OF THE INVENTION

The focus industry would primarily be electricity generation, and for agriculture. However, any industry that uses energy can be supported as well.

This wind turbine has the advantage of all wind turbines: it does not consume valuable irreplaceable resources and has basically no negative impact on the environment.

The Z-333 Energy Management System is expected to capture more power from the wind and convert it into electricity at a lower cost, less maintenance, and a better human safety factor than any other wind turbine or methods of producing energy. The slow rotation keeps danger to a minimum. The Z-333 Energy Management Systems Vertical Axis Wind Turbine will be so safe that cities could permit its use near homes, factories, shopping centers, stores, and schools where power is needed. (See FIG. 1a) This a wind turbine which uses a unique aerodynamically “balanced” reversing wing to provide ‘lift’ and torque. BENEFIT-1 By aerodynamically “balancing” the wing it becomes easy to manage with the use of a fulcrum. Thus the less energy spent positioning the wing to the correct ‘angle of attack’ the more energy for the generation of electricity. BENEFIT-2. With aerodynamic “balancing” there is a minimum pressure on the switch and other mechanical parts, thus extending their life. (See FIG. 2) The wings are constructed with an extremely low cost fabric (such as polyethylene) tightly stretched from top to bottom. BENEFIT-1 This gives the overall structure more strength and stability. BENEFIT-2 each wing has no metal or other material, beside the fabric, between its top and bottom resulting in lower upwind wing air resistance. BENEFIT-3 Since each wing has no metal, or other material between its top and bottom it has a lower manufacturing and installation cost. (See FIG. 3)

The wings have thin photovoltaic cells (PV) included on both sides. (See FIG. 4) There are no vertical-axis wind turbines that utilize thin photovoltaic cells directly on the airfoil fabric. BENEFIT-1 The Z-333 Energy Management Systems Vertical Axis Wind Turbine will make an excellent PV support for a very small additional cost. The sun is there striking the wind turbine anyway. Capturing all this energy is practically free. BENEFIT-2 the PV covering will protect and extend the life of the fabric. BENEFIT-3 the water is an excellent reflector of the suns rays, thus making a sea or lake based wind turbine a better PV holder than a land based system.

The Z-333 Energy Management Systems Vertical Axis Wind Turbine is also comprised of high-wind safety mechanisms.

1) A flexible tower which bends in high winds. (See FIG. 5)

BENEFIT-Excess energy during a storm will be spent bending the tower instead of breaking and destroying something.

2) A ‘high-wind-shut-off-switch’ which points the wings' leading edge directly into the wind when wind speed exceed a predetermined amount. (See FIG. 6a-c)

3) A multi generator system that uses magnetic fields to brake the rotational speed of the tower and maintain it at a fixed RPM. (See FIG. 7a-b) This concept of the multi generator/alternator system is to control the revolutions of the vertical axis to a minimum relying on torque rather than speed to power the aforementioned devices. BENEFIT-1 Slow rotation keeps vibration to a minimum. BENEFIT-2 This keeps noise to a minimum. BENEFIT-3 Slow rotation keeps maintenance to a minimum. BENEFIT-4 This slow RPM eliminates the danger to birds and bats being killed flying into it. BENEFIT-5 Slower rotation speeds means a more economical, ultra light construction; therefore, easier to construct a super gigantic wind turbine to grab the first 2,500 feet above sea level, where the air is more dense and powerful. BENEFIT-6 Energy can be captured from a wider range of winds from breeze to near hurricane. BENEFIT-7 Most wind turbines have only one generator. Once a generator reaches its rated output, the wattage basically remains the same, even when the RPM is doubled. For example, 2×RPM=1.1×kWh. With this invention 2×RPM=2×kWh. BENEFIT-8 No high tip speed. No danger of a blade breaking and hitting people or animals on the ground. BENEFIT-9 Lower overall cost.

Note: There is a multi-generator wind turbine patent by Arnold Lund U.S. Pat. No. 4,585,950 April 1986 (Expired). However this patent proposes to use the generators to provide a fixed generator RPM to maintain a fixed electrical frequency i.e.: 60 Hz. The Z-333 Energy Management Systems Vertical Axis Wind Turbine uses the generators as a brake to keep the vertical axis shaft at a minimum predetermined RPM.

The small version may use ‘removable generator panels’. Benefit-1 User may use less generators/alternators in a low wind area or more in high wind area. Benefit-2 Repairs and maintenance is easier, faster and less costly. (See FIG. 7b & FIG. 12)

Another version may use a unique multi-level “Pancake Generator” which is made from several photo-chemically etched copper circuit boards instead of traditional wound coils (See FIG. 8a-b). Each pancake will be activated in the same manner as the generators mentioned above.

There are three different bases for the Z-333 Energy Management Systems Vertical Axis Wind Turbine;

1) The Standard Economical Base at ground level. (See FIG. 9a-b) This may incorporate a large built in battery with several lead acid cells, or other energy storage devise and the control panel.

2) The Power House Base which has various prefabricated metal stories. The first floor could be a car garage, or a water tank, or a shed, etc. The next floor could be a studio apartment, animal food storage compartment or a water tank, etc. The third floor could be a bed room, equipment room, water or food storage, etc. (See FIG. 11a-b)

BENEFIT-1 the tower is really the “cost” of a wind turbine. For a small additional cost the tower could be converted to a valuable long lasting, maintenance-free facility or low cost housing. BENEFIT-2 Water can be stored during windy times and be used all year round.

3) The Sea Base is a floating buoy which enables the wind turbine to capture energy out at sea, or on large lakes, out of sight where the wind is strong, and constant (See FIG. 11a-c). No other wind turbine has a semi-submergible wind turbine base with ballast. BENEFIT-1 Extremely large wind turbines can be erected more easily and at a lower cost. They can be assembled on their side in large bodies of water, and then by filling the ballast they point upwards without the use of cranes. (See FIG. 11c) BENEFIT-2 this construction enables the wind turbine to be much more stable and efficient utilizing the air where it's the most dense at sea level. Also water promotes a very constant wind, for example the North Pacific Ocean. BENEFIT-3 This easy construction enables an offshore location that can be placed far from eyesight, thus appeasing those who feel wind turbines are not aesthetically pleasing. BENEFIT-4 Obviously there are no “landlords” in the ocean charging rent for wind turbine space.

The Sea Base can be equipped with a complete facility to produce hydrogen and oxygen gases from water. This would be accomplished by on-site recharging of boron or similar pellets for use in hydrogen fuel cells (See FIG. 11b). No other wind turbine has an integrated hydrogen-oxygen producer. BENEFIT-1 It is more efficient to produce hydrogen from water at the energy source than to export the energy several miles via electricity and then produce it. BENEFIT-2 With economical hydrogen production everyone will be more interested in using hydrogen fuel cells in the future. We will all breathe cleaner air. BENEFIT-3 With everyone using economical hydrogen fuel derived from this invention many countries will have all the energy they need, and won't have to import oil from foreign countries.

All versions of the Z-333 Energy Management Systems Vertical Axis Wind Turbine may be equipped with an ‘Intelligent Control Box’. This box, which can be used on any piece of equipment, offers the user; —Perfect sine wave inverter 115vac.—Battery charging options: wind turbine only, or other permanent source (i.e.: PV panel), house current, temporary external (i.e.: plug-in gasoline generator).—Inverter connection (auto back meter) compatible with all power companies.—Automatic battery over-charge switching to a heater, back meter, other permanent (i.e.: External battery storage).—Battery Fast-Discharge Alarm via a horn or cell phone.—Vandalism Alarm, activated by infrared sensors; with the option of one or more of the following; 30,000 volt “electric fence” type of protection; horn, speaker (with pre-recorded voice) or cell phone that can call local police, or owner.—Cell Phone Communication; Will call the owner with a pre-recorded voice messages (erasable and re-recordable ), battery fast-discharge alarm, vandalism alarm, short circuit alarm, low battery alarm.—Internet Graphs (posted periodically via cell phone); wind speeds, energy captured, energy consumption, overcharge kWh consumed by heater etc.—Twelve or more, independent-circuit station timers; Each with an adjustable voltage option (12 vdc, 115 vac, 220 vac set by a safety switch via screw driver) also each having an adjustable on-time off-time in milliseconds.

No other wind turbine incorporates an axis-centered energy storage flywheel, charged by means of a continually variable transmission. BENEFIT-1 Electricity spot market values vary greatly with supply and demand, from late at night to daytime and during a heat spell for example. By storing the energy captured at a low demand period it can be sold at a high demand period for several times more. BENEFIT-2 a flywheel/alternator can deliver a more regulated flow of energy, saving costs in inverter equipment. BENEFIT-3 the direct drive of the axis-centered flywheel allows more energy to be stored, as opposed to converting the power to electricity then to flywheel stored energy then back to electricity. (See FIG. 11b)

No other wind turbine has an axis-centered centrifugal pump. BENEFIT-1 since the Z-333 Energy Management Systems Vertical Axis Wind Turbine will generate a lot of torque it can power a centrifugal pump with a larger diameter. A larger diameter means that the liquid will be pressurized to a much greater extent thus pumping it farther, higher and faster. Plus better for supplying desalinization equipment. BENEFIT-2 the direct drive axis centered pump allows more energy to be used doing the job it was intended to do. Less energy lost converting wind energy to electrical energy then to pump action. (See FIG. 11b)

Rubber-like Gear No other windmill uses a rubber-like gear to transmit energy (See FIG. 12). BENEFIT—Regular gears wear out very quickly when their ratio exceeds 6/l. This enables a slow turning Vertical Axis Wind Turbine shaft to step up revolutions faster using fewer gears.

### BRIEF DESCRIPTION OF THE DRAWINGS

FIG. 1a is an aerial view of the Z-333 Energy Management Systems Vertical Axis Wind Turbine.

FIG. 1b is a side view of the Z-333 Energy Management Systems Vertical Axis Wind Turbine with various parts numbered.

FIG. 2 is a side view of the Z-333 Energy Management Systems Vertical Axis Wind Turbines wing with the aerodynamically balanced proportions.

FIG. 3 illustrates the pull of the wing fabric.

FIG. 4 illustrates the photovoltaic cells on a wing.

FIG. 5 illustrates the flexible tower shaft.

FIG. 6a illustrates the switching mechanism

FIG. 6b illustrates an exploded view of the switching mechanism.

FIG. 6a illustrates the spring stops of the switching mechanism.

FIG. 7a illustrates the top view of the multi-generator arrangement and the large/small gear relation.

FIG. 7b illustrates the removable generator racks.

FIG. 8a illustrates the main components of the multi-level pancake generator.

FIG. 8b illustrates the multi-level pancake generator with subcomponents.

FIG. 9a illustrates the standard base.

FIG. 9a illustrates the standard base with a battery cell and control panel.

FIG. 10a illustrates the Power House base as a typical farm storage shed

FIG. 10B illustrates the Power House base as a typical home.

FIG. 11a illustrates the Sea Base.

FIG. 11b illustrates the Sea Base opened.

FIG. 11c illustrates the Sea Base being erected.

FIG. 12 illustrates the removable generator rack with the rubber-like covered shaft engaged to the large metal ring.

FIG. 13 illustrates a top view of the Z-333 Energy Management Systems Vertical Axis Wind Turbine.

FIG. 14 illustrates the rotation and approximate angle of attack of a wing as it passes through the circle.

### DESCRIPTION OF THE PREFERRED EMBODIMENTS

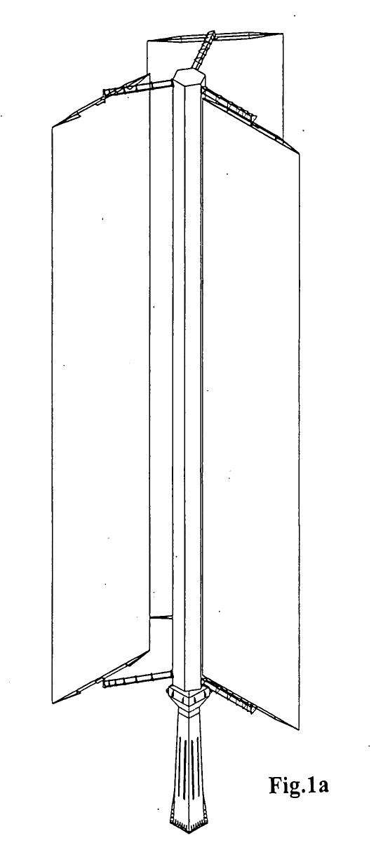

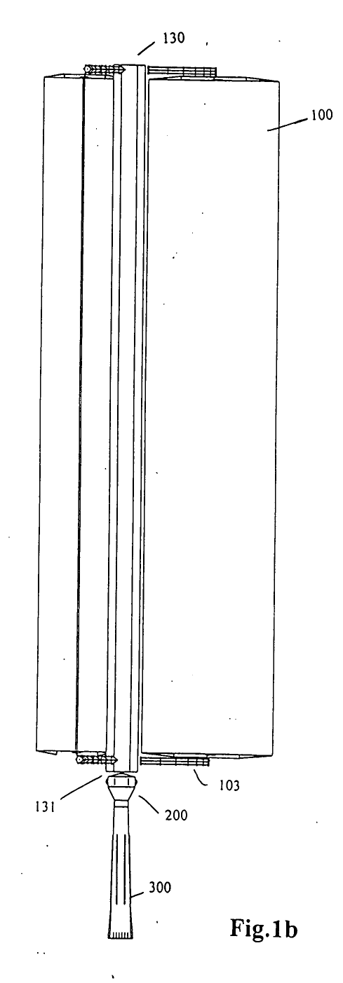

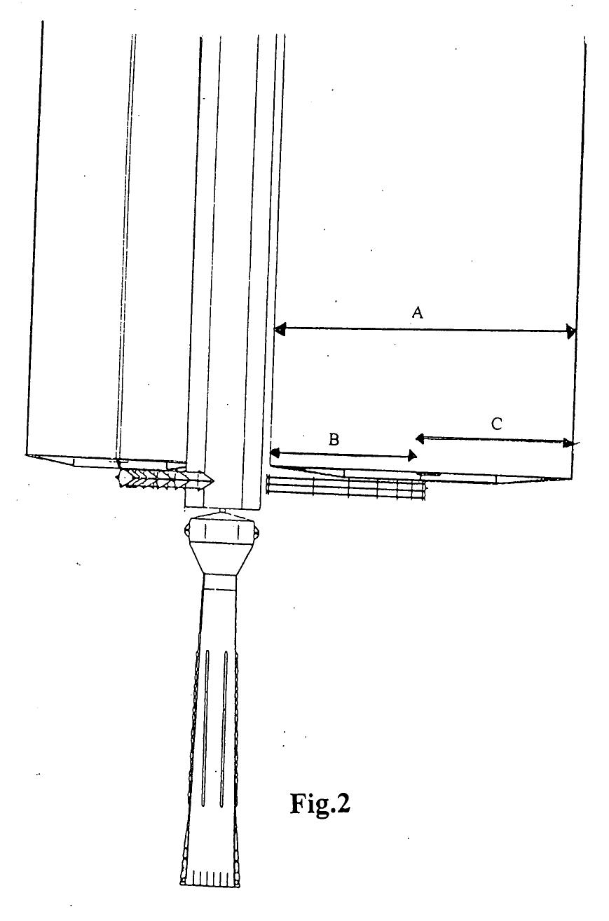

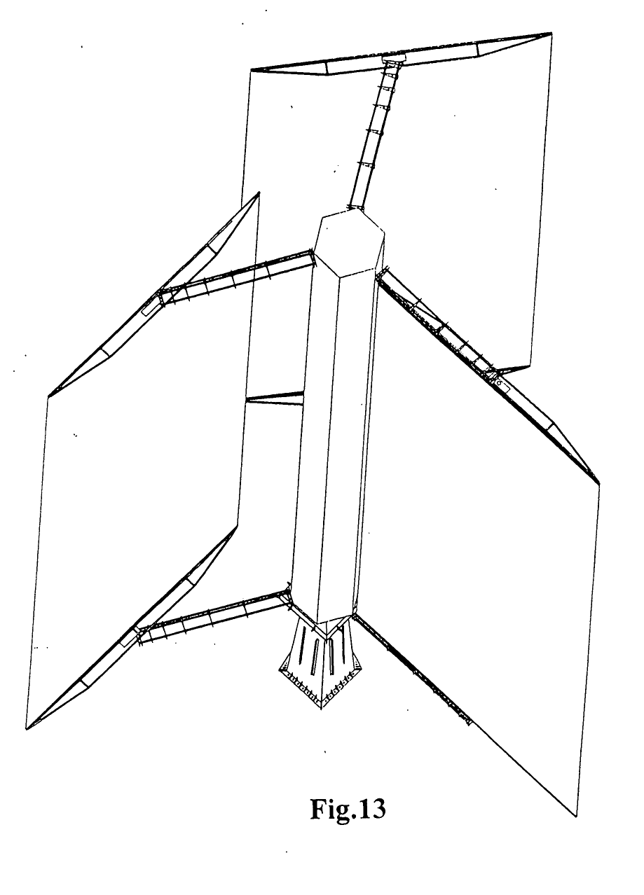

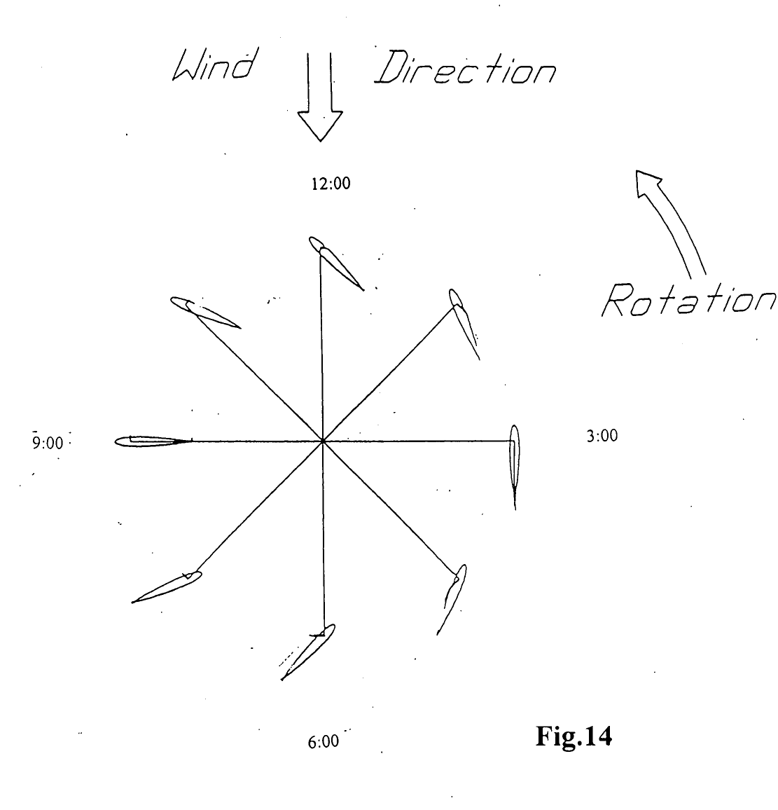

The Z-333 Energy Management Systems Vertical Axis Wind Turbine has two or more vertical wings 100 (See FIG. 1b). The wings ‘lift’ and drag forces push the ends of the arms like feet pushing bicycle pedals. (See FIGS. 13-14)

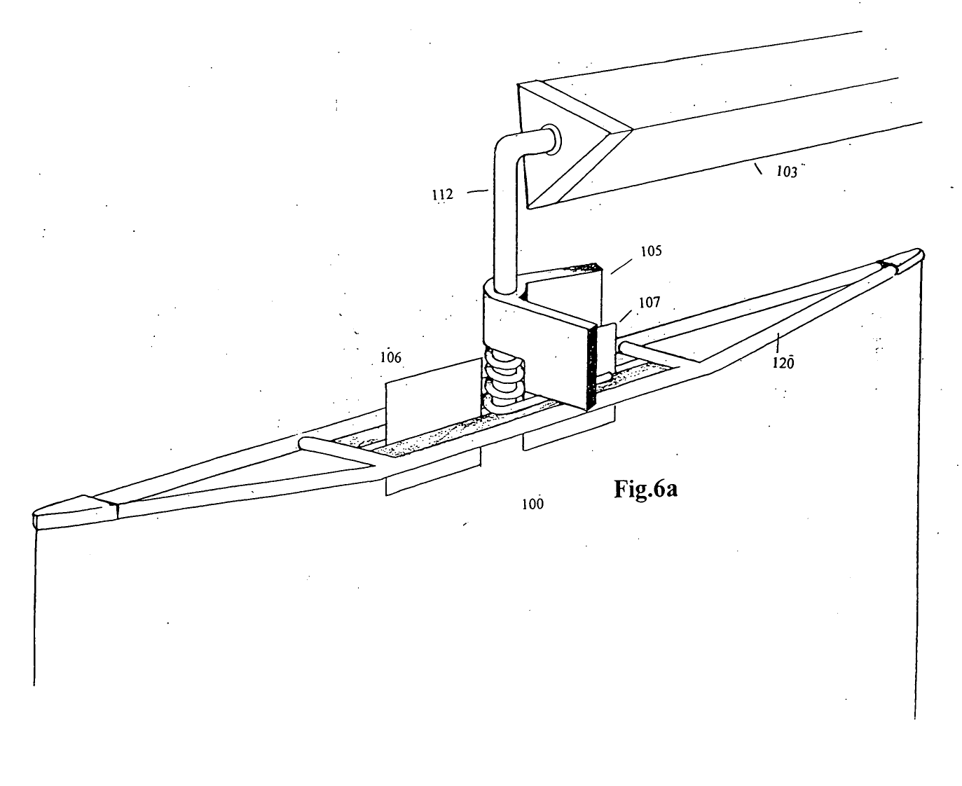

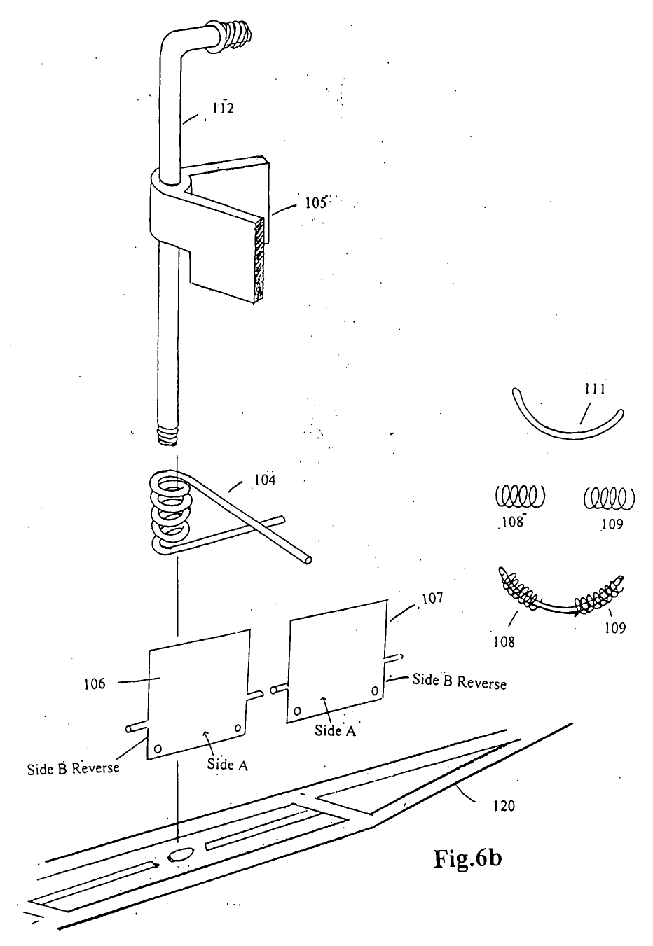

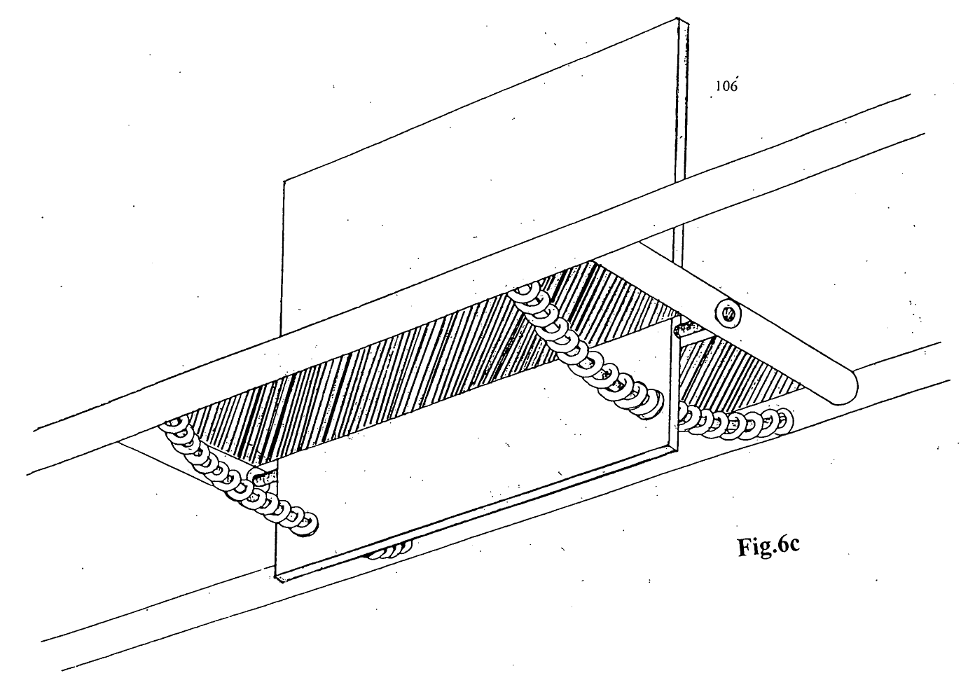

Each wing 100 is independent of each other and pivots independently of the arms 103. (See FIG. 6b) Each wing has a top and bottom, spring 104, brake 105, and switch 106-107 that causes the leading edge of the wing to move to and to stay at it's most efficient ‘attitude’. (See FIGS. 13-15)

The wing is in its neutral position when the arm 103 is at the 3:00 o'clock position (See FIG. 14). When the arm 103 is pulled counter clockwise into the 2:00 o'clock position, switch 107 begins to push against spring 104 maintaining it at the proper ‘angle of attack’ during the movement counter clockwise from 2:00 to 1:00-12:00-11:00. At that angle the switch 107 pushes against the brake 105 and remains in constant contact with it until the arm 103 moves to the 7:00 O'clock position. Then spring 104 pushes the tail of the wing edge 120 away from the brake 105. At this point the wind catches the wing 100 and swings it around until switch 106 hits the other side of the brake 105 placing the wing 100 at the best ‘angle of attack’ for the 6:00 o'clock position.

As the arm 103 moves toward the 5:00 to 3:00 position, the wing 100 gradually adjusts to remain at the best ‘angle of attack’. At the 3:00 position the cycle starts all over again.

In normal operations switch 106 and 107 remain firm. However in case of high winds both sides A of the switch 106 and 107 will allow the spring 104 and brake 105 to pass to the other side of the wing edge 120. This allows the wing 100 to feather and the leading edge, of the wing 100 to point into the wind in a safe neutral position.

In case of a change in the wind direction, both sides B of the switch 106 and 107 easily allow the spring 104 and brake 105 to pass to the other side of the wing 100. This way the wing 100 can move itself into the correct position instead of locking in the wrong position and fighting the other wings 100 in the other positions.

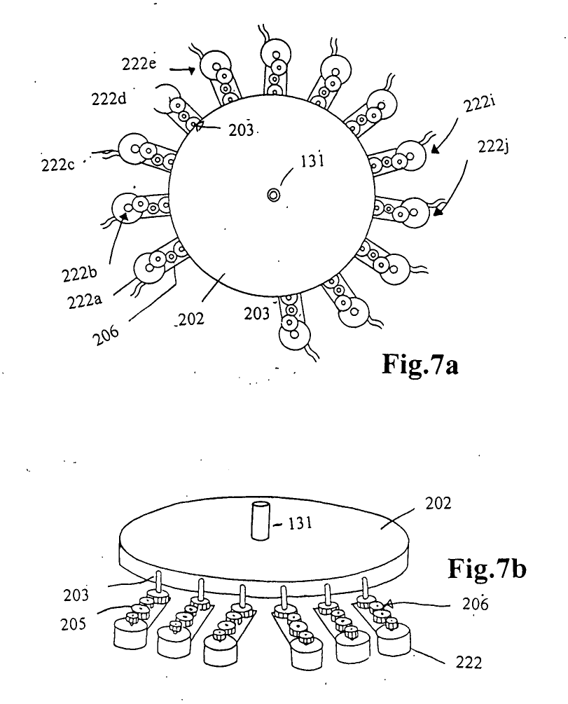

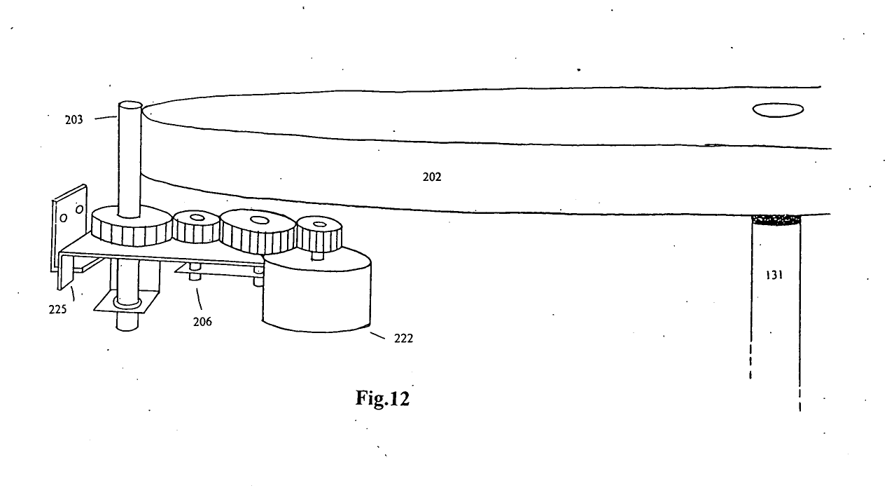

As the wings push the arms, the shaft 131 turns. Down at the bottom of the shaft, 131 and fixed to the shaft, there is a large ring 202 mounted horizontally and rotates with the shaft 131 (See FIG. 7a-b and FIG. 12). Around the large horizontal ring are one or more generators 222, each with a very small rubber-like covered metal shaft 203, connected to a step-up gearbox 205 which is connected to a generator 222 (or other load device). When there is no wind, the generators are not ‘engaged’ with the large horizontal metal ring 202.

As the wind causes the shaft 131 and large horizontal metal ring 202, to rotate at its predetermined speed limit of 20 or 30 RPM, for example, then the first generator 222a connects the next generator. The second generator becomes engaged either physically or electronically by means of a governor-switch 206. Since the first generator is permanently engaged with the large metal ring 202, it turns at its rated RPM almost instantly.

As the wind increases and the large horizontal ring 202, the first generator 222a and second generator 222b turn faster; the next generator 222c is engaged by means of the second generators 222b governor switch 206, thus braking the wind turbine shafts 131 rotational actions with the forces of its two magnetic fields. When the wind increases to a higher velocity, then the forth generator 222d engages in the same manner, and the shaft 131 is braked somewhat more. This procedure continues with more generators 222e-z engaging, as the wind increases in velocity. The system is always keeping the shaft 131 rotating slowly at approximately 20-30 RPM, for example.

This multi-generator system allows the Z-333 Energy Management Systems Vertical Axis Wind Turbine to grasp energy from the faintest breeze, yet continue operation in higher winds with the maximum energy captured.

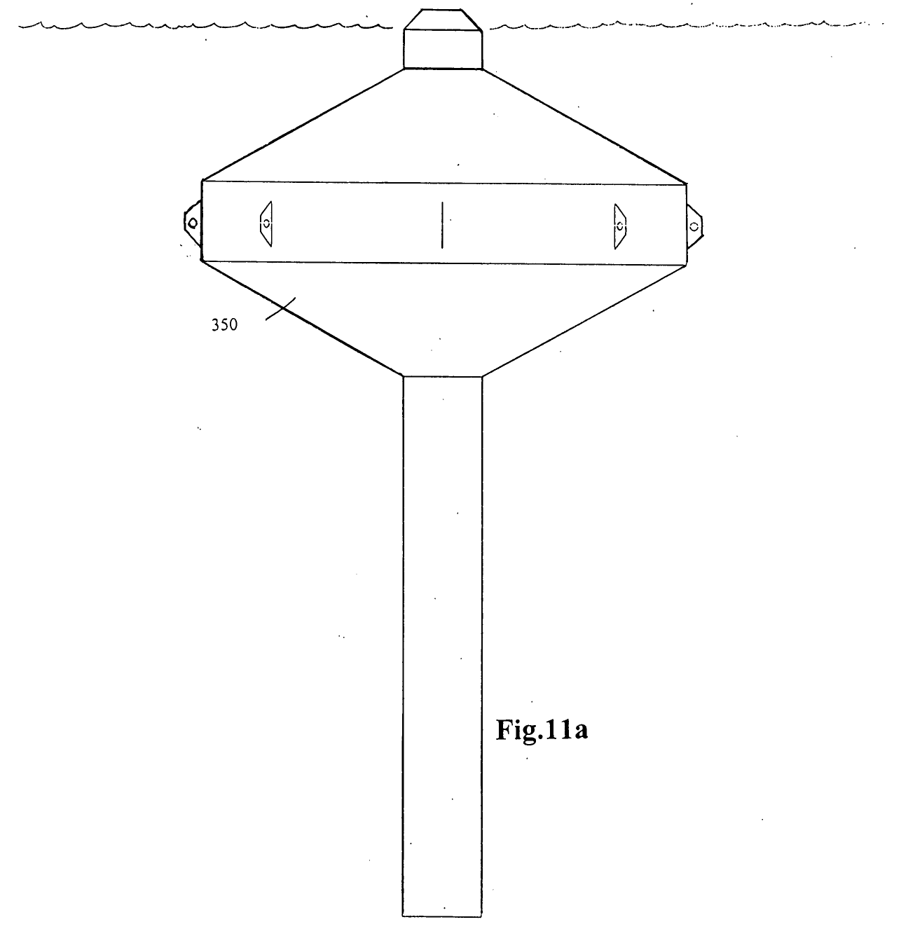

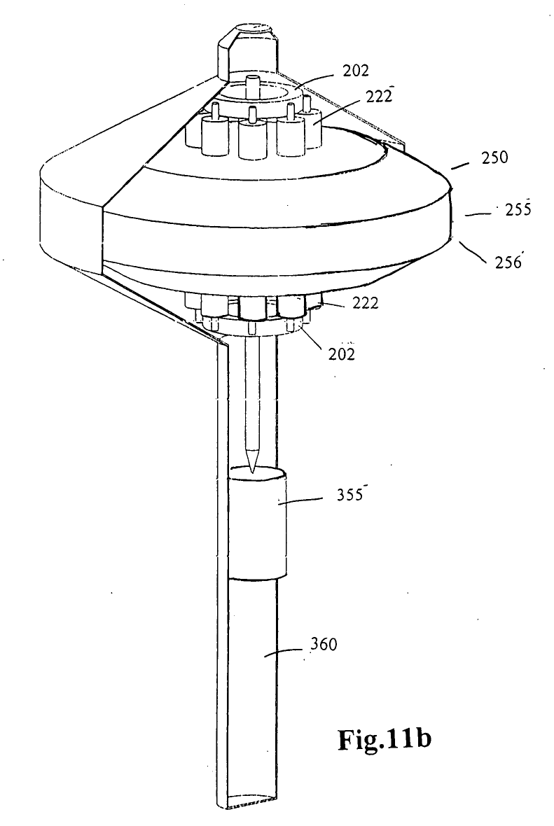

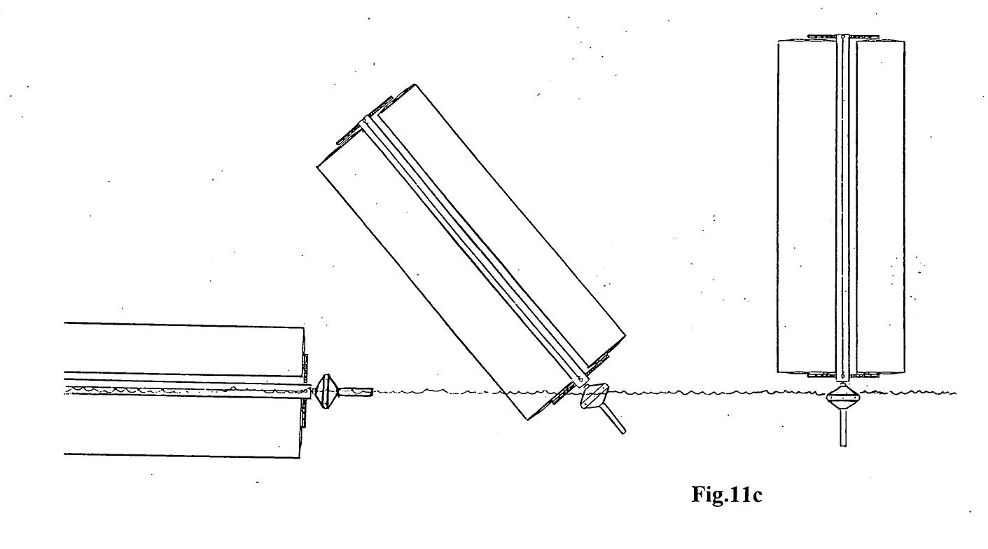

With power generation at the base, several types of equipment can be connected regardless of the weight. This includes, but is not limited to a continuously variable transmission powering a large axis centered pump 255 and/or flywheel 250, and so forth (See FIG. 11b).

The Z-333 Energy Management Systems Vertical Axis Wind Turbine uses a unique aerodynamically “balanced” (See FIG. 2) reversing (See FIG. 14) wing 100 to provide ‘lift’ and torque. Aerodynamic “balancing” of the wing, is accomplished by placing the pivot point at almost one half of the way between the wing's 100 leading edge and the wing's 100 trailing edge. “Balancing” it becomes easy to manage with the slight use of a fulcrum. An example of the dimensions would be (See FIG. 2) A=19 feet B=9 feet and C=10 feet. Thus the less energy spent positioning the wing to the correct ‘angle of attack’ the more energy for the generation of electricity.

With aerodynamic “balancing” there is a minimum pressure on the switch 106 and 107 and other mechanical parts, thus extending their life (See FIG. 2).

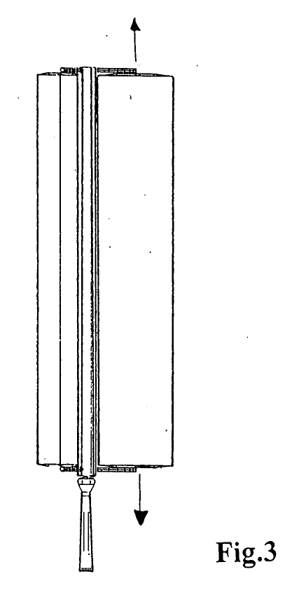

The wings 100 are constructed with an extremely low cost fabric (such as polyethylene) tightly stretched (See FIG. 3) from top to bottom, around and between two wing edges 120. This gives the overall structure (See FIG. 1a) more strength and stability. Each wing 100 has no metal or other material, beside the fabric, between its top and bottom edges 120, resulting in lower upwind wing air resistance. Since each wing has no other material between its top and bottom it has a lower manufacturing and installation cost (See FIG. 3).

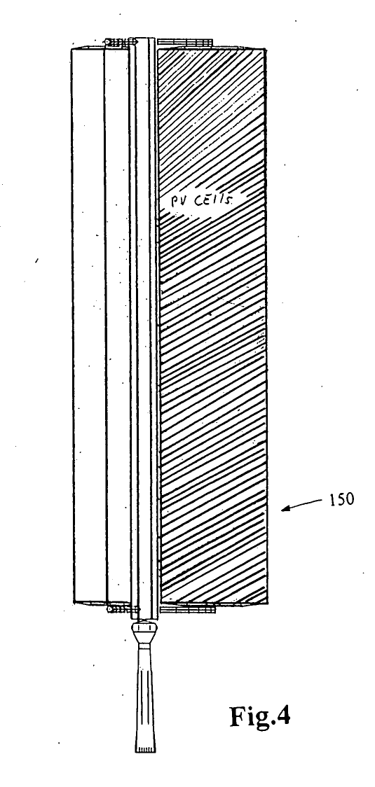

The wings 100 have thin photovoltaic cells (PV) 150 included on both sides. (See FIG. 4) There are no vertical-axis wind turbines that utilize flexible thin photo-voltaic cells directly glued on to the airfoil fabric. Due to the low voltage of the cells a transformer/inverter, or heavy copper cables, may be built into the wings leading edge 100. The Z-333 Energy Management Systems Vertical Axis Wind Turbine (See FIG. 1a) will make an excellent PV support for a very small additional cost. The sun is there striking the wind turbine anyway. Capturing all this energy is practically free. The PV covering 150 will protect and extend the life of the fabric. The water is an excellent reflector of the suns rays, thus making a sea (See FIGS. 11a-b-c) or lake based wind turbine a better PV holder than a land based system.

The Z-333 Energy Management Systems Vertical Axis Wind Turbine has the following high wind safety mechanisms.

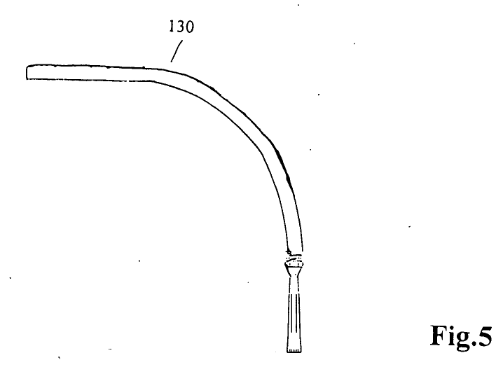

1) The flexible tower 130 which bends in high winds. (See FIG. 5) Excess energy during a storm will be spent bending the tower instead of breaking and destroying something.

2) The high-wind-shut-off-switch 106 and 107 points the wing's leading edge directly into the wind when wind speed exceeds a predetermined amount (See FIG. 6a).

3) The multi-generator system uses magnetic fields to brake the rotational speed of the tower and maintain it at a fixed RPM as mentioned above (See FIG. 7a-b).

The small version may use removable generator panels 225 (See FIG. 12). User may customize their wind turbines by using fewer generators in a low wind area or season or, more generators in high wind area or season (See FIG. 7a). The entire generator 222, step-up gear 205, governor 206, and connecting rubber-like covered shaft 203, are all built into one removable panel 225.

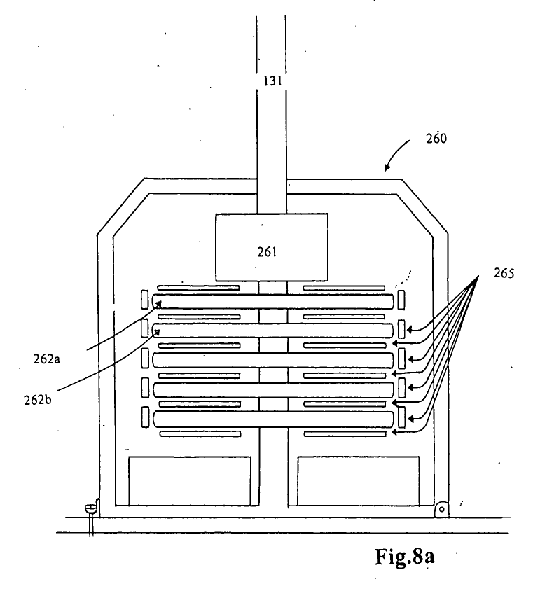

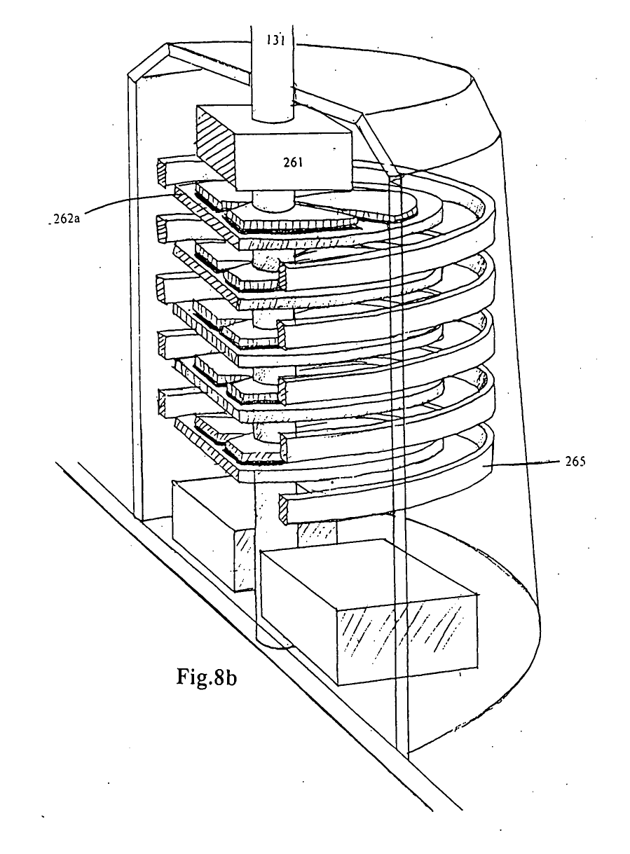

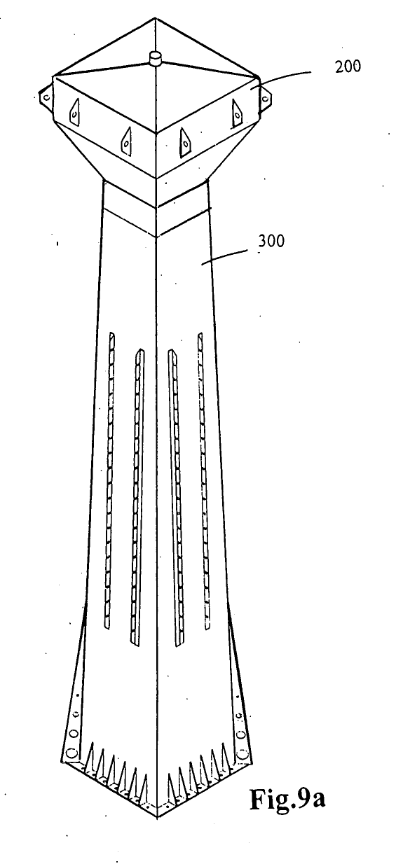

Another version is a unique multi-level ‘Pancake Generator’ 260 which is made from several photo-chemically etched copper circuit boards 262a instead of traditional wound coils (See FIG. 8a). Each pancake will be activated in generally the same manner as the multi-generator system mentioned above. As the wind turns the shaft 131 rotation is increased by step-up gears 261 the first pancake 262a is engaged. Then as the wind increases, more pancakes are electronically engaged, thus braking the Vertical Axis Wind Turbines shaft and keeping it at a steady RPM. (See FIG. 8a-b) There are different bases for the Z-333 Energy Management Systems Vertical Axis Wind Turbine;

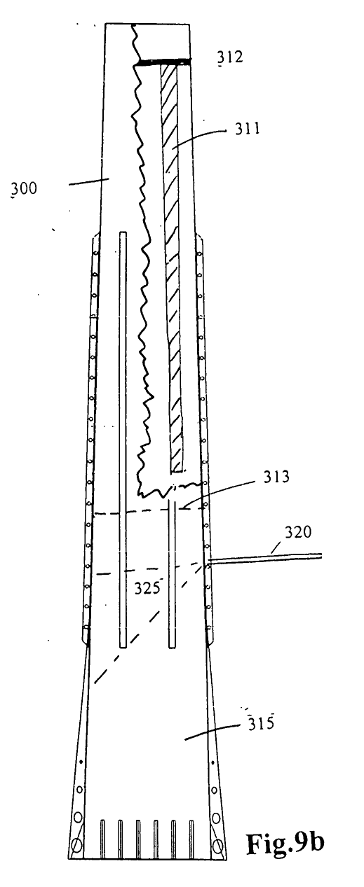

1) The Standard Base 300 at ground level (See FIG. 9a-b). The base may have various lead acid cells 311, or other form of storing energy incorporated in it. These cells 311 may hang from a support 312 and enclosed in low cost acid proof bags.

The base may have a door 320 which enables the end used to access the control panel 325 and also use the rest of the space for storage.

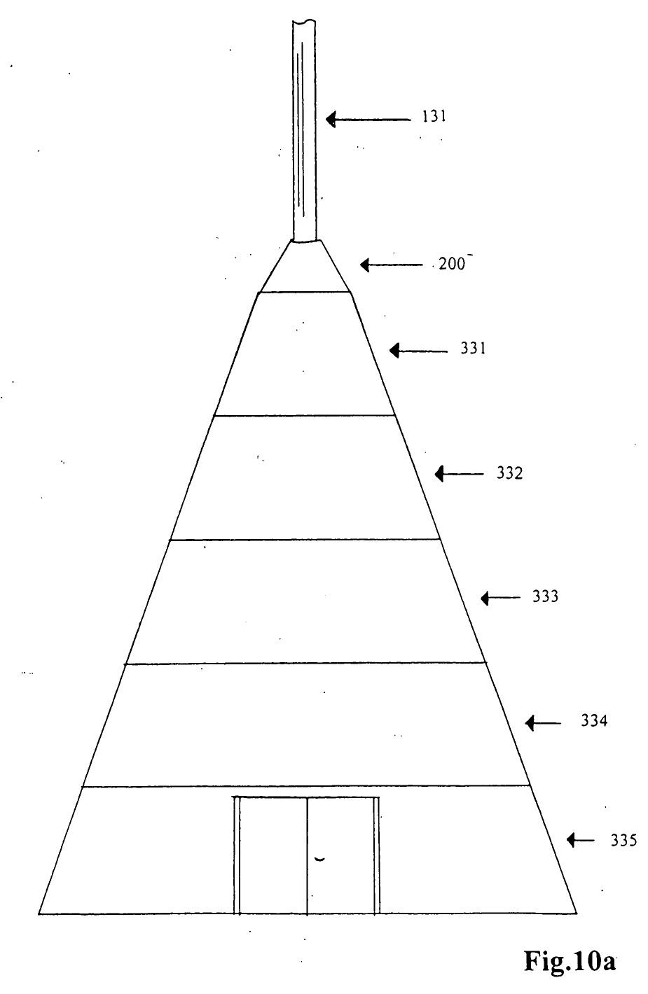

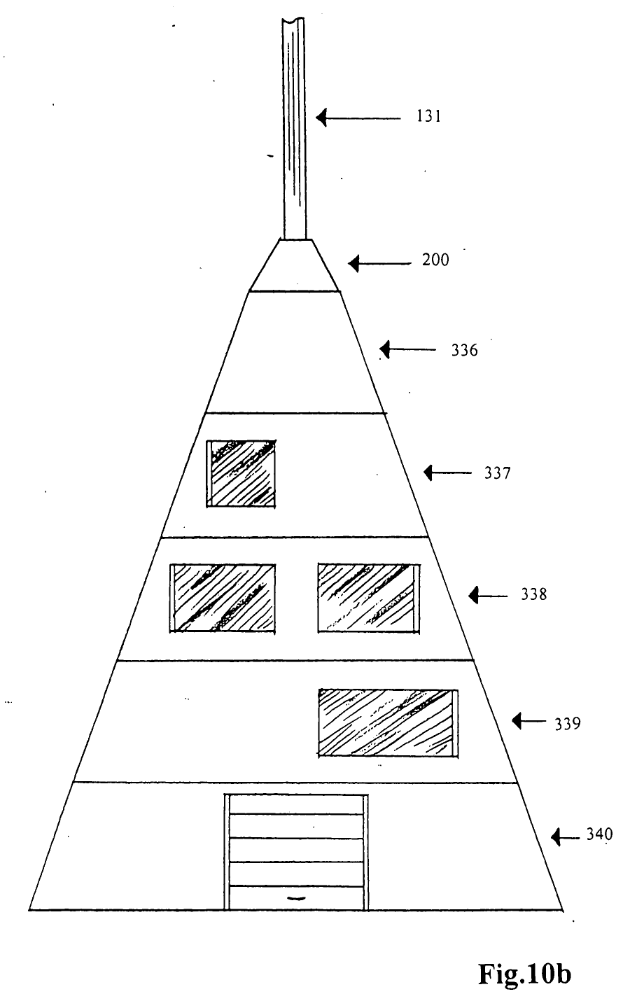

2) The Power House Base which has various prefabricated sections 331-340 for each story. The end users may customize their Power House to fit their particular needs. The first floor could be a car garage 340, or a water tank 331, or a shed 335, etc. The next floor could be a studio apartment 339, or animal food storage compartment 334, etc. The third floor could be a living area 338, equipment room 333, water or food storage 333, etc. (See FIG. 10a-b).

3) The Sea Base is a floating buoy 350 which enables the wind turbine to capture energy out at sea, or on large lakes, out of sight and where the wind is strong, and constant (See FIG. 11a-b). No other wind turbine has a semi-submergible wind turbine base with ballast that is used to erect the tower. Extremely large wind turbines can be erected more easily and at a lower cost. They can be assembled on their side in large bodies of water. Then by filling the ballast 360 they point upwards without the use of cranes (See FIG. 11c). This construction technology enables the wind turbine to be much more stable and efficient utilizing the air where it's the most dense, at sea level. Also water promotes a very constant wind, for example the North Pacific Ocean. This easy construction enables an offshore location that can be placed far from eyesight, thus appeasing those who feel wind turbines are not aesthetically pleasing. Obviously there are no “landlords” in the ocean charging rent for wind turbine space.

The Sea Base may be equipped with a complete facility 355 to produce hydrogen and oxygen gases from water. This would be accomplished by on-site recharging of boron or similar, pellets for use in hydrogen fuel cells (See FIG. 11b). No other wind turbine has an integrated hydrogen-oxygen producer 355. It is more efficient to produce hydrogen from water at the energy source than to export the energy several miles via electricity and then produce it. With economical hydrogen production everyone will be more interested in using hydrogen fuel cells, in the future. We will all breathe cleaner air. With everyone having economical hydrogen fuel available many countries will have all the energy they need and won't have to import oil from foreign countries.

All versions of the Z-333 Energy Management Systems Vertical Axis Wind Turbine may be equipped with an ‘Intelligent Control Box’ 325. This box, which can be used on any piece of equipment, offers the user;—Perfect sine wave inverter 115 vac.—Battery charging options: wind turbine only, or other permanent source (i.e.: PV panel), house current, temporary external (i.e.: plug-in gasoline generator).—Inverter (auto back meter) compatible with all power companies.—Automatic battery over-charge switching to a heater, back meter, other permanent (i.e.: External battery storage).—Battery Fast-Discharge Alarm via a horn or cell phone.—Vandalism Alarm, activated by infrared sensors; with the option of one or more of the following; 30,000 volt “electric fence” type of protection; horn, speaker (with pre-recorded voice) or cell phone that can call local police, or owner.—Cell Phone Communication; Will call the owner with a pre-recorded voice messages (erasable and re-recordable ), battery fast-discharge alarm, vandalism alarm, short circuit alarm, low battery alarm.—Internet Graphs (posted periodically via cell phone); wind speeds, energy captured, energy consumption, overcharge kWh consumed by heater etc.—Twelve or more, independent-circuit station timers; Each with an adjustable voltage option (12 vdc, 115 vac, 220 vac set by a safety switch via screw driver) also each having an adjustable on-time off-time in milliseconds (See FIG. 9b).

The Z-333 Energy Management Systems Vertical Axis Wind Turbine may incorporate an axis-centered energy storage flywheel 250, charged and discharged with a continually variable transmission (CVT). Electricity spot market values vary greatly with supply and demand from late at night to daytime, and rise dramatically during a heat spell. A flywheel/alternator 250 can deliver a more regulated flow of output energy. The direct drive of the axis-centered flywheel 350 allows more energy to be stored, as opposed to converting the power to electricity then, to a flywheel then to electricity. (See FIG. 11b)

The Z-333 Energy Management Systems Vertical Axis Wind Turbine may have an axis-centered centrifugal pump 255. Since the Z-333 Energy Management Systems Vertical Axis Wind Turbine will generate a lot of torque, it can power a centrifugal pump 255 with a larger diameter driven by means of a CVT. A larger diameter means that the liquid will be pressurized to a much greater extent thus pumping it farther, higher and faster. Plus it will be better for supplying desalinization equipment 256. The direct drive axis-centered pump 255 allows more energy to be used doing the job it was intended to do. Less energy is lost converting wind energy to electrical energy then to pump action. (See FIG. 11b)

I claim:

1. A vertical axis wind turbine comprising a base, a vertically extending shaft rotatably mounted in said base, a plurality of vertically spaced, radially extending first arms having their inner end portions fixedly connected to said shaft at each end portion thereof, a plurality of vertically spaced, radially extending second arms pivotally connected to said first arms, a vertically extending wing fixedly connected at each axial end thereof to a respective second arm, each wing having a leading edge and a trailing edge, a fixed spindle depending from the outer end portion of each first fixed arm, each second arm being freely rotatably mounted on a respective spindle, a torsion spring having one end connected to a respective fixed arm and the opposite end connected to a respective second arm for biasing the respective wing to a first position and brake means operatively connected to the first and second arms to limit the rotation of each wing relative to the first arms.

2. A vertical axis wind turbine, according to claim 1, wherein the brake means comprises first and second abutments secured respectively to the first fixed arm and the second pivotal arm on one side of said spindle, and third and fourth abutments secured respectively to the first fixed arm and the second pivotal arm on the opposite side of said spindle, whereby the pivotal movement of the wings is limited to thereby maintain the leading edge of each wing to its most efficient attitude.

3. A vertical axis wind turbine, according to claim 1, wherein each wing is constructed of a fabric tightly stretched from top to bottom between the second arms.

4. A vertical axis wind turbine, according to claim 1, wherein the pivotal connection of each second arm to each first arm is positioned substantially one half the distance between the leading and trailing edges of each wing, whereby the wing is aerodynamically balanced.

5. A vertical axis wind turbine, according to claim 1, wherein the vertically extending rotatable shaft is flexible.

6. A vertical axis wind turbine, according to claim 3, wherein a plurality of photovaltaic cells are mounted on the fabric wings.

7. A vertical axis wind turbine, according to claim 1, wherein a multi-generator system is mounted in said base and connected to said rotatable shaft.

8. A vertical axis wind turbine, according to claim 7, wherein an energy storing component is mounted in said base and connected to said generator system.

9. A vertical axis wind turbine, according to claim 1, wherein the base comprises a floating buoy whereby the wind turbine captures energy at sea.

10. A vertical axis wind turbine, according to claim 9, wherein ballast is employed in the buoy for erecting the vertically extending shaft.

11. A vertical axis wind turbine, according to claim 7, wherein said multi-generator system employs magnetic fields to brake the rotational speed of the shaft and maintain the speed of the shaft at a fixed rate of rotation.

12. A vertical axis wind turbine, according to claim 7, wherein the multi-generator system includes a large disc connected to the end of the rotatable shaft, at least one generator positioned in proximity to the peripheral edge of said disc, and an elastomeric covered metal shaft operatively connected between the peripheral edge of the disc and the generator, whereby the generator is driven by the disc.

13. A vertical axis wind turbine, according to claim 7, wherein the multi-generator system includes removable panels containing said generator system.

14. A vertical axis wind turbine, according to claim 8, wherein a programmable intelligent control box is mounted in said base.

15. A vertical axis wind turbine, according to claim 1, wherein the base comprises a plurality of prefabricated interchangeable modules.

16. A vertical axis wind turbine, according to claim 8, wherein the energy storing component comprises an axis centered energy storage flywheel/alternator.

17. A vertical axis wind turbine, according to claim 1, wherein a shaft centered centrifugal pump is connected to the rotatable shaft.

18. A vertical axis wind turbine, according to claim 9, wherein desalinization equipment is mounted in said base.

19. A vertical axis wind turbine, according to claim 9, wherein hydrogen and oxygen producing equipment are mounted in said base.

20. A vertical axis wind turbine, according to claim 7, wherein the multi-generator system includes multi-pancake generators.
